(19) United States
(12) Patent Application Publication
(10) Pub. No.: US 2015/0228127 A1
(43) Pub. Date: Aug. 13, 2015

(54) OBD Interface Device Having Processor Running Diagnostics Web Server to Provide Platform Independent Diagnostics

(71) Applicant: Uwe Ross, Lansdale, PA (US)

(72) Inventor: Uwe Ross, Lansdale, PA (US)

(21) Appl. No.: 14/620,811

(22) Filed: Feb. 12, 2015

Related U.S. Application Data
(60) Provisional application No. 61/938,740, filed on Feb. 12, 2014.

(51) Int. Cl. G07C 5/00

(52) U.S. Cl. CPC G07C 5/008

(57) ABSTRACT

An on-board diagnostics (OBD) interface device to provide an interface between a vehicle's OBD system and a wireless device. The device includes an OBD connector to physically connect to an OBD port in a vehicle so as to communicate with the vehicle's OBD system. The device includes a wireless interface to provide a communications link to the wireless device. The device includes a processor running a diagnostics program. The diagnostics program is configured as a web server so that it can be accessed remotely using any device having a web browser. The remote access to the diagnostics program provides a platform independent diagnostic program as any wireless device, regardless of platform, can access the program. The wireless device can perform diagnostics without the need for a diagnostics application being loaded thereon.

### PRIORITY

This application claims priority under 35 USC §119 to U.S. Provisional Application 61/938,740 entitled “Wireless OBD interface having embedded web server to provide platform independent diagnostics” filed on Feb. 12, 2014 and having Uwe Ross as inventor. Application 61/938,740 is herein incorporated by reference.

### BACKGROUND

Modern vehicles come equipped with a multitude of on-board computers that monitor and process data from a variety of sensors to determine various attributes about the vehicle. The information from these sensors can be used to track different attributes, detect problems and/or diagnose potential issues with the vehicle. The information from the various on-board computers is available for further processing and/or viewing via an on board diagnostics (OBD) port. Various devices have been developed that can connect to the OBD port and display certain information available in various different forms which can be used for monitoring or diagnostics.

The devices may be specifically for retrieving data about the vehicle via the OBD port and presenting, processing and/or diagnosis of the data (OBD tools). Alternatively, a computer may be utilized to run a diagnostics program thereon. Using a computer eliminates the need for specific OBD tools. However, the computer utilizes a specific operating system and any applications running thereon need to be configured accordingly. As the Windows operating system was the dominant operating system for many years, many of the diagnostics programs were designed exclusively for Windows. However, some of the diagnostics programs may have been developed for users of other operating systems (e.g., Apple) instead of or in addition to the Windows version.

With the proliferation of mobile devices (e.g., smart phones, tablets), the availability of devices that can be utilized to run diagnostics programs has increased dramatically. However, the mobile devices utilize different operating systems (e.g., Apple, Android, Blackberry). Accordingly, a diagnostic program may be limited in the type of devices that it can operate with. Alternatively, the diagnostics program may have a plurality of versions so that an appropriate version can be utilized with a corresponding device. However, a diagnostics program that is limited in the types of devices it can be used with or that requires multiple versions that may need ongoing updates based on changes to the operating systems is not desirable.

### SUMMARY

What is needed is a diagnostics tool that is platform (both hardware and operating system) independent so that a user can access the information using any device. Furthermore a wireless connection between the OBD port and the device running the diagnostics tool would provide additional flexibility.

An on-board diagnostics (OBD) interface device may provide an interface between a vehicle's OBD system and a wireless device. The device may physically connect to an OBD port in a vehicle so as to communicate with the vehicle's OBD system. The device may include an OBD connector to physically connect to the OBD port. The device may wirelessly connect to and communicate with the wireless device. The device may include a wireless interface to provide the communications link to the wireless device. The device may include a processor running a diagnostics program. The diagnostics program may be configured as a web server so that it can be accessed remotely using any wireless device having web browser. The remote access to the diagnostics program provides a platform independent diagnostic program as any wireless device, regardless of platform, can access the program. The wireless devices may perform diagnostics without the need for a diagnostics program being loaded thereon.

### BRIEF DESCRIPTION OF THE DRAWINGS

The features and advantages of the various embodiments will become apparent from the following detailed description in which:

FIG. 1 illustrates an example block diagram of an on-board diagnostics (OBD) interface device providing an interface between a vehicle's OBD system and a wireless device, according to one embodiment.

FIG. 2 illustrates an example functional block diagram of the OBD interface device, according to one embodiment.

FIG. 3 illustrates an example function block diagram of the platform independent diagnostics program, according to one embodiment.

FIG. 4 illustrates an example flow chart for configuring the ODB interface device as a platform independent diagnostics tool, according to one embodiment.

FIG. 5 illustrates an example functional block diagram of the OBD interface device, according to one embodiment.

### DETAILED DESCRIPTION

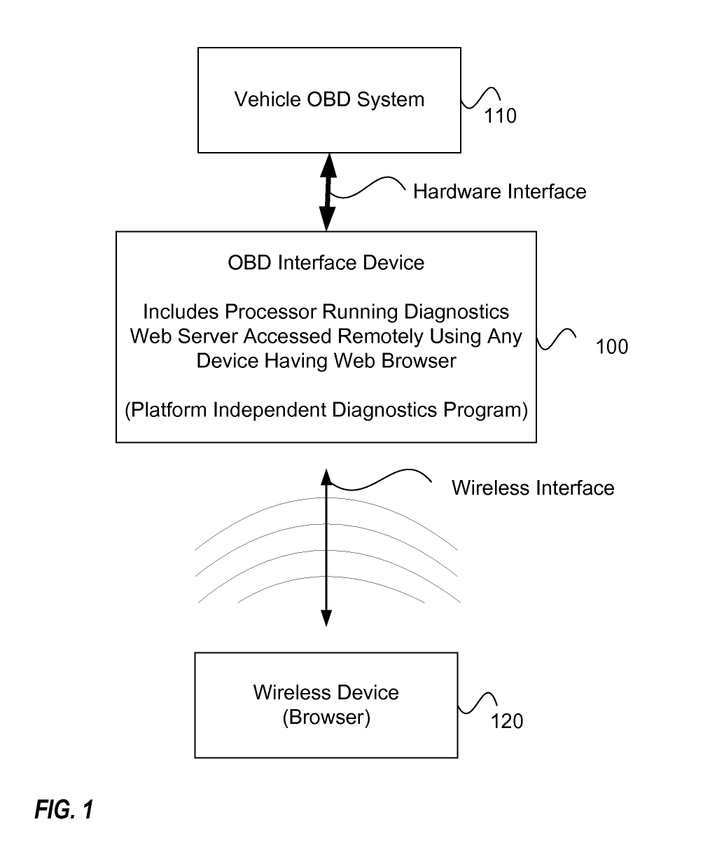

FIG. 1 illustrates an example block diagram of an on-board diagnostics (OBD) interface device 100 providing an interface between a vehicle's OBD system 110 and a wireless device 120. The device 100 physically connects to an OBD port in a vehicle so as to communicate with the vehicle's OBD system 110. The device 100 includes an OBD connector (not separately illustrated) to physically connect to the OBD port. The device 100 is a hardware interface for the ODB port. The device 100 wirelessly connects to and communicates with the wireless device 120. The device 100 includes a wireless interface (not separately illustrated) to provide the wireless communications link to the wireless device 120. The device 100 includes a processor (not separately illustrated) running a diagnostics program. The diagnostics program is configured as a web server so that it can be accessed remotely using any device having web browser. The remote access to the diagnostics program provides a platform independent diagnostic program as any wireless device 120, regardless of platform, can access the program. The wireless devices 120 can perform diagnostics without the need for a diagnostics application being loaded thereon.

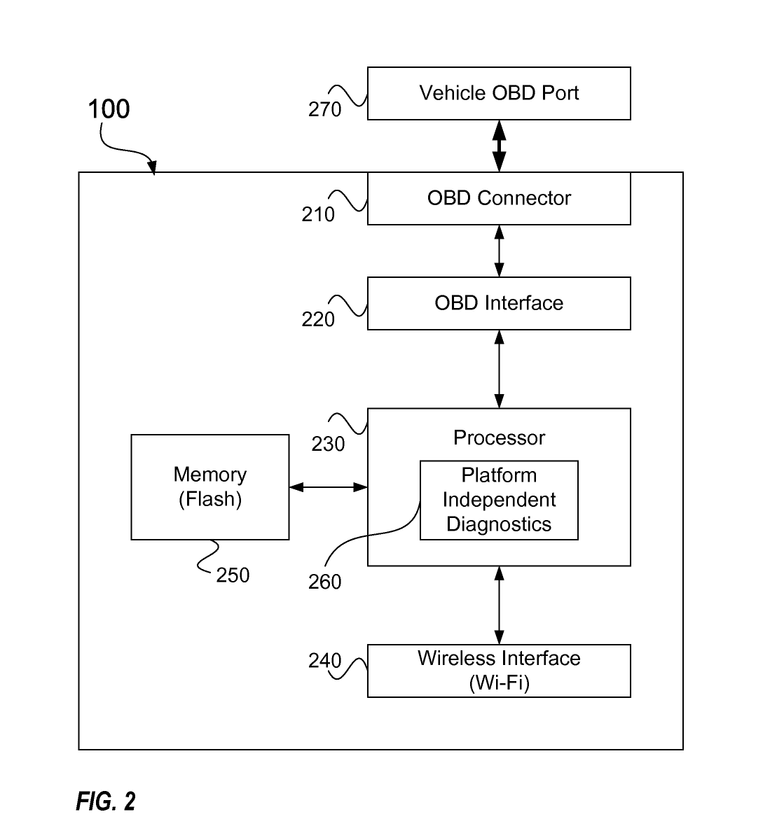

FIG. 2 illustrates an example functional block diagram of the OBD interface device 100. The device 100 includes an OBD connector 210, an OBD interface 220, a processor 230, a wireless interface 240 and memory 250.

The OBD connector 210 is to plug into a vehicle's ODB port 270 and provide the physical connection with a vehicle's OBD system 110. Signals to/from the vehicle's OBD system are provided over this physical connection. The device 100 also receives power via this physical connection. As will be discussed in more detail later, the power may be provided by the battery of the vehicle when the vehicle is not running or from the system (e.g., alternator) when the vehicle is running The OBD interface 220 provides the communication link between the device 100 and the vehicle's OBD system 110 (e.g., converts signals between OBD protocol and processor protocol).

The processor 230 may be capable of running a diagnostics program 260 (executing instructions making up the diagnostics program) that is maintained in a non-transitory processor readable storage medium. The non-transitory processor readable storage medium may be included on the processor 230 or may be remote from the processor 230 (e.g., memory 250). The diagnostics program 260 may receive data from the vehicle's OBD system 110 and be able to process the data for diagnostics and/or presentation. The exact function of the diagnostics program 260 may vary and the actual functionality of the diagnostics program 260 is in no way intended to limit the scope of the current invention. The diagnostics program 260 may be configured as a web server so that it can be accessed remotely using any device 120 that has a web browser. The remote access enables the diagnostics program 260 to be platform independent. The device 120 accessing the diagnostics program 260 can perform diagnostics without the need for any software being loaded thereon.

The wireless interface 240 provides a wireless access point and communication link between the device 100 and a wireless device 120 utilized by a user to run the diagnostics program 260. The wireless interface 240 may include a wireless transceiver (not separately illustrated) to provide a wireless connection. The wireless connection may be, for example, a wireless local area network (WLAN) such as that compliant with IEEE standard 802.11.x (Wi-Fi), where x currently is B and G versions of the standard. The wireless interface 240 provides the communication link between the device 100 and the wireless device 120 (e.g., converts signals between wireless protocol and processor protocol). The wireless device 120 may be any device that has a display, a wireless interface and a web browser. The wireless device 120 is not limited to any particular hardware configuration, operating system, or manufacturer. For example, the device may be a computer, a smart phone, or a tablet. The wireless device 120 may be running any operating system including, but not limited to, Windows, Apple, Android, Blackberry or Linux. The wireless device 120 may be used anywhere within the range of the wireless (e.g., Wi-Fi) access point provided by the wireless interface 240.

The memory 250 may store certain information related to the diagnostics program 260. The information may include, but is not limited to, raw data received from the OBD system 110, processed data, diagnostic information, information entered by a user, and data dictionaries to define diagnostics codes for different vehicles. The information may be retrieved for later processing or analysis. The memory 250 may also store the diagnostics program 260 or portions thereof). While the memory 250 is illustrated as a single component it is not limited thereto as it may be several different memory components. Furthermore, while the memory 250 is illustrated as a separate component it is not limited theteto as it may be at least partially be part of the processor 230 (e.g., processor includes on-board memory). According to one embodiment, the memory 250 may be flash.

The device 100 acts as a hardware interface to the vehicle's OBD 110 and a wireless interface to a wireless device 120. The device 100 being configured as a web server enables diagnostics to be performed remotely using any wireless device 120 (e.g., WiFi) that has a modern browser, without needing to install any software on that device. Accordingly, the device 100 provides a platform independent diagnostics program.

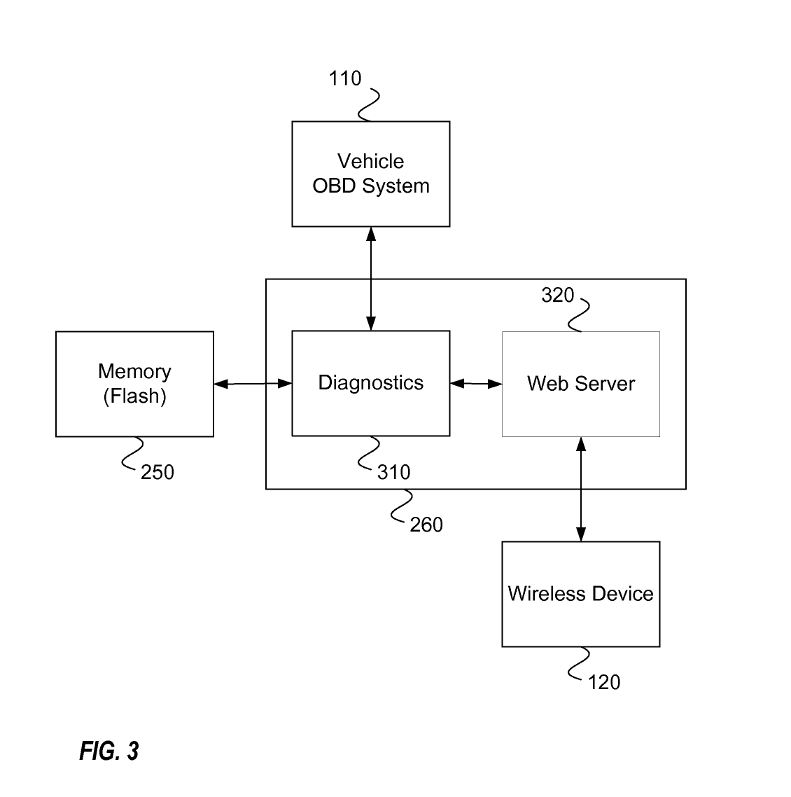

FIG. 3 illustrates an example function block diagram of the platform independent diagnostics program 260. The diagnostics program 260 may include two main modules, a diagnostics module 310 and a web server module 320. The diagnostics module 310 may communicate with the vehicle's OBD system 110 via the OBD interface 220, the OBD connector 210 and the OBD port 270. The diagnostics module 310 may save data to and retrieve data from the memory 250. The diagnostics module 310 may analyze the data received, diagnose potential problems, and prepare data for presentation to a user. The web server module 320 may communicate with the wireless device 120 via the wireless interfaces 240. The web server module 320 may display information (e.g., raw data, analysis, diagnosis information) to the wireless device 120 in the form of a web page displayed on the browser of the wireless device 120. The web server module 320 may also receiver information (e.g., commands, requests, input) from a user that the user entered into a web page. The web server module 320 and the diagnostics module 310 may communicate with each other. For example, the user commands/instructions received via web server module 320 may be provided to diagnostics module 310 and the diagnostics module 310 may retrieve and/or generate the appropriate information and provide it to the web server module 320 for presentation to the user.

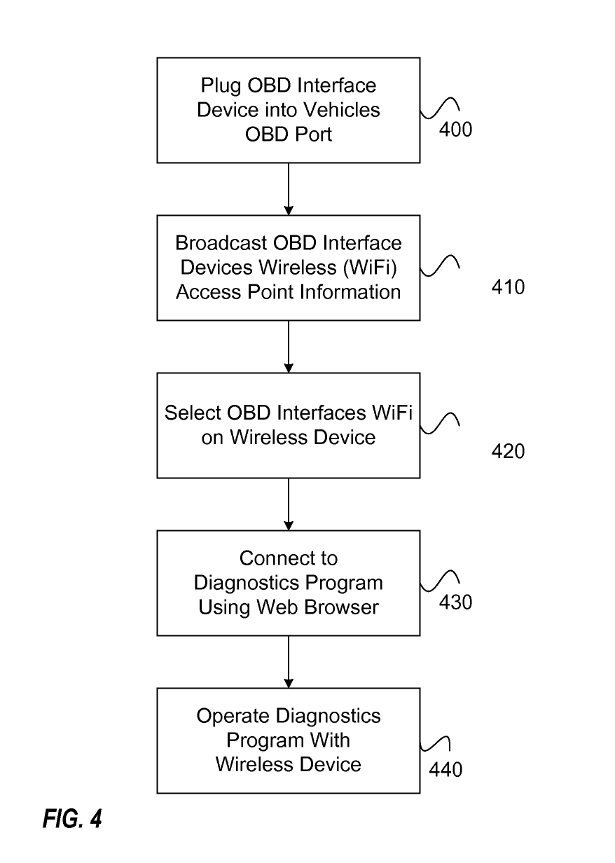

FIG. 4 illustrates an example flow chart for configuring the ODB interface device 100 as a platform independent diagnostics tool. The OBD connector 210 of the OBD interface device 100 is plugged into a vehicles OBD port 270 (400). When plugged in the ODB port 270, the OBD interface device 100 receives power from the vehicle (e.g., battery, system). The OBD interface 100 then broadcasts its wireless access point information (410). Any wireless devices 120 within range of the access point can select this access point. A user wishing to access the OBD interface device 100 will select the OBD interface access point as their wireless (e.g., WiFi) access point on their wireless device 120 (420). Once connected to the OBD interface devices wireless access point, a user will use the wireless devises web browser to connect to the diagnostics program (430). Once the wireless device 120 connects to the diagnostics program 260, the diagnostics program 260 may be operated by the wireless device 120, such that the wireless device 120 controls diagnostics operations performed and presents the diagnostics information thereon (440).

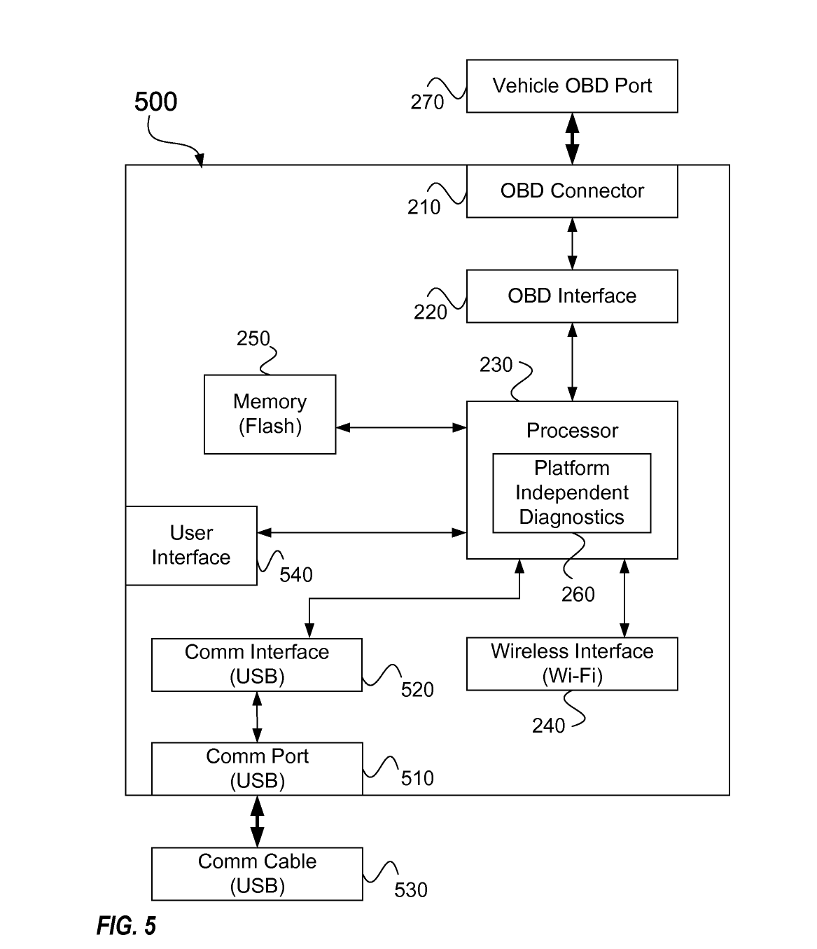

FIG. 5 illustrates an example functional block diagram of the OBD interface device 500. The device 500 includes the same functions as the device 100 illustrated in FIG. 2 (namely the OBD connector 210, the OBD interface 220, the processor 230, the wireless interface 240, the memory 250 and the diagnostics program 260). In addition, the device 500 may include a communications port 510 and a communications interface 520. The communications port 510 is to receive a communications cable 530 that is connected to a computing device and provide a physical (wired) connection with the computing device. Signals to/from the computing device are provided over this physical connection. The device 500 may also receive power via this physical connection. The communications interface 520 provides the communication link between the device 500 and the computing device (e.g., converts signals between communications protocol and processor protocol). According to one embodiment, the communications port 510 may be a USB port, the communications interface 520 may be a USB interface and the communications cable 530 may be a USB cable.

The wired communication link provided by the communications port 510, the communications interface 520 and the communications cable 530 permits any computing device supporting the wired communications link (e.g., USB) to communicate with the OBD interface device 500 regardless of whether it supports wireless communications. The remote access to the diagnostics program 260 provides a platform independent diagnostic program as any computing device, regardless of platform, can access the program. The computing device can perform diagnostics without the need for a diagnostics application being loaded thereon.

Furthermore, the device 500 may include a user interface 540. The user interface 540 may provide an indication as to the status of the device 500. For example, the user interface 540 may include one or more LEDs to provide the status. Examples of the status provided may include power, communications with the OBD system, operational state of OBD system, operational state of wireless interface, and operational state of processor. The status may be provided simply by the LED being on or off or may be more complex and include different colors and blinking The user interface 540 may further include user input devices (e.g., buttons, switches). The user input devices may be used, for example, to turn on/off, reset, toggle between modes. The user input devices may simply be pressed or switched to take an action or the action taken may depend on the position of a switch or the length of time a button is depressed.

According to one embodiment, the diagnostics program running on the OBD interface device 100/500 need not be used. Rather, the OBD interface device 100/500 can simply be used to provide wireless, or wired, access to the OBD data. For example, a device running a platform specific diagnostics program that typically obtained the data via an OBD cable connection between the device and the OBD port can use the wireless interface to eliminate the need for the wired interface. Alternatively, the computing device could use a standard cable to connect to the OBD interface device rather than the OBD cable.

According to one embodiment, the wireless interface 240 of the OBD interface device 100/500 may connect to other wireless networks that have access to the Internet. The OBD interface 100/500 may then utilize the other networks to connect to the Internet. The OBD interface 100/500 may connect to a cloud based diagnostics program to, for example, provide additional functionality not available thereon, to download information needed to operate (such as fault codes for specific vehicles), or to transmit diagnostics information to a third party.

According to one embodiment, the diagnostics program 260 may limit the number of vehicles that it can be utilized with. When the OBD interface 100/500 connects to the OBD system 110 it receives the vehicle identification number (VIN). The VIN may be recorded in the memory 250. Once the memory contains a certain number (e.g., 10) of VINs, the OBD interface 100/500 may not permit diagnostics to be performed for any more vehicles.

As previously noted the OBD interface 100/500 receives power via the OBD port 270. The power may be provided by the battery when the vehicle is not running and may be provided by the system (e.g., alternator) when the vehicle is running If the OBD interface 100/500 is left in a non-operational vehicle for long periods of time it may drain the battery. According to one embodiment, the diagnostics program 260 may determine whether it is receiving power from the battery or from the system based on voltage level. If it is determined that the OBD interface 100/500 is receiving power from the battery and the diagnostics program has not been active for some period of time (e.g., 60 seconds), the OBD interface 100/500 may enter a low power mode or may power itself off as a precaution to draining the battery.

What is claimed:

1. An on-board diagnostic (OBD) interface device to provide an interface between an OBD system of a vehicle and a wireless device desiring to run diagnostics on the vehicle, the OBD interface device comprising:
an OBD interface to provide a communication link with the OBD system;
a processor including memory to store a diagnostics program configured as a web server, wherein when the processor executes the diagnostics program it enables the wireless device to perform diagnostics on the vehicle without a platform specific diagnostics application being loaded on the wireless device; and
a wireless interface to provide a wireless communication link with the wireless device.

2. The device of claim 1, further comprising an OBD connector to connect to an OBD port of the vehicle.

3. The device of claim 1, further comprising memory to store diagnostics information.

4. The device of claim 1, wherein the wireless device is platform independent.

5. The device of claim 1, wherein diagnostics information for the vehicle is presented to the wireless device and instructions for what diagnostics to perform on the vehicle are received from the wireless device.

6. The device of claim 1, further comprising a user interface to provide status information for the device.

7. The device of claim 1, wherein the wireless interface is a WiFi interface.

8. The device of claim 1, further comprising
a communications port to receive a cable from a computing device;
a communications interface to provide a communications link between the device and the computing device via the cable.

9. The device of claim 8, wherein the communication pot is a USB port and the communications interface is a USB interface.

10. The device of claim 1, wherein the wireless interface is further to connect to a wireless network to provide access to the Internet.

11. The device of claim 1, wherein when the wireless device is executing a platform specific diagnostics application, the device is to provide wireless communications between the OBD system and the wireless device.

12. The device of claim 1, wherein the wireless device uses a web browser to access the diagnostics program.

13. An on-board diagnostic (OBD) interface device comprising:
an OBD connector to connect to an OBD port of a vehicle;
an OBD interface to provide a communication link between the device and an OBD system for the vehicle;
a processor;
a non-transitory processor readable storage medium to store a platform independent diagnostics program that when executed by the processor causes the processor to present diagnostics information for the vehicle to a wireless device and to receive instructions for what diagnostics to perform on the vehicle from the wireless device; and
a wireless interface to provide a wireless communication link between the device and the wireless device.

14. The device of claim 13, wherein the platform independent diagnostics program is configured as a web server.

15. The device of claim 13, wherein the platform independent diagnostics program can be accessed via a web browser of the wireless device.

16. The device of claim 13, wherein
the wireless interface broadcasts its information;
the wireless device selects the wireless interface to establish wireless communications with the device; and
the wireless devices utilizes a web browser to access the platform independent diagnostics program.

17. The device of claim 13, further comprising memory to store diagnostics information.

18. A method comprising
plugging an on-board diagnostic (OBD) interface device into an OBD port in a vehicle, wherein the OBD interface device includes a processor having memory to store a diagnostics program configured as a web server and a wireless interface, wherein when the processor executes the diagnostics program it enables a wireless device to perform diagnostics on the vehicle without platform specific diagnostics application being loaded on the wireless device;
broadcasting information about the wireless interface;
selecting the wireless interface on the wireless device to establish a wireless link between the OBD interface device and the wireless device; and
using a web browser on the wireless device to access the diagnostics program.

19. The method of claim 18, further comprising
presenting diagnostics information for the vehicle on the wireless device;
transmitting instructions for what diagnostics to perform on the vehicle from the wireless device to the diagnostics program.

20. The method of claim 18, further comprising storing diagnostics information in memory included on the OBD interface device.
